(19) United States
(12) Patent Application Publication
(10) Pub. No.: US 2021/0355751 A1
(43) Pub. Date: Nov. 18, 2021

(54) FLEXIBLE GUARD RAIL FOR TODDLER PROTECTION

(71) Applicant: Zhanpeng Liang, Guangzhou (CN)

(72) Inventor: ZHANPENG LIANG, Guangzhou (CN)

(21) Appl. No.: 15/929,696

(22) Filed: May 16, 2020

(51) Int. Cl. E06B 9/08

(52) U.S. Cl. CPC E06B 9/08; E06B 2009/002

(57) ABSTRACT

The present invention provides a flexible and adjustable apparatus which is designed as a guard rail for toddler's protection. The apparatus comprising: an upper seat (1), an upper fix ring (2), an upper fix plate (3), an upper mounting base (4), a main body (5), two buttons (6), a switch bar (7), a upper base cover (8), a knob (9), a cloth winding tube (10), an upper sleeve (11) for the cloth winding tube, a fixing tooth (12) for the cloth winding tube, a base (13), a lower fixing plate (14), a gasket (15), a first washer (16) for the cloth winding tube, a bottom cover (17), a supporting rod (18), a first spring (19), a second spring (20), a lower mounting base (21), a pressure ring (22), a second washer (23) for the cloth winding tube, a bottom gasket (24), a mesh cloth (25), a handle rod (2), a handle upper sleeve (27), a handle lower sleeve (28), a spring limit (29), a pin (30), a third spring (31), a button for the handle rod (32), a linkage rod (33), a first button handle (34), a second button handle (35), a handle lower base (36), a handle upper base (37), a fourth spring (38), a first set of screws (39), a second set of screws (40), a third set of screws (41), a fourth set of screws (42), a fifth set of screws (43) and a fifth spring (44), which are all mechanically coupled with a main body component and a handle end component.

### FIELD OF THE INVENTION

The present invention generally relates to a flexible and adjustable mechanical apparatus used as a convenient guard rail to protect children's safety. More particularly, the invention is related to a flexible and adjustable toddler guard rail which can be conveniently carried and used anywhere a user wants to use it.

### BACKGROUND OF THE INVENTION

Guard rail, guardrails, or protective guarding, in general, are a boundary feature and may be a means to prevent or deter access to dangerous or off-limits areas while allowing light and visibility in a greater way than a fence. To protection toddlers' safety, special guard rails are used to block them from walking out from the doors of a house or an apartment or a hotel room without an adult' permission.

Traditional toddler guard rail is made of a solid structure and a lock mechanism which could not be opened by a toddler. The solid structure, such as a wood frame, can be coupled to one side of the door frame via one or more hinges and to the other side via the lock mechanism. The disadvantage of this type of guard rail is that it is not convenient to move or carry.

What is needed is a portable toddler guard rail which can be adjusted and packed conveniently and which can be rolled up automatically when it is released and can be extended when it is to be used.

### SUMMARY OF THE INVENTION

The present invention discloses a portable toddler guard rail which can be adjusted and packed conveniently and which can be rolled up automatically when it is released and can be extended when it is to be used. It consists of a ribbon of cloth, plastic, or fiber glass which can be rolled up automatically. It can be installed and uninstalled conveniently.

In one preferred embodiment, the present invention teaches a flexible and adjustable toddler guard rail, which comprises the following: an upper seat (1), an upper fix ring (2), an upper fix plate (3), an upper mounting base (4), a main body (5), two buttons (6), a switch bar (7), an upper base cover (8), a knob (9), a cloth winding tube (10), an upper sleeve (11) for the cloth winding tube, a fixing tooth (12) for the cloth winding tube, a base (13), a lower fixing plate (14), a gasket (15), a first washer (16) for the cloth winding tube, a bottom cover (17), a supporting rod (18), a first spring (19), a second spring (20), a lower mounting base (21), a pressure ring (22), a second washer (23) for the cloth winding tube, a bottom gasket (24), a mesh cloth (25), a handle rod (2), a handle upper sleeve (27), a handle lower sleeve (28), a spring limit (29), a pin (30), a third spring (31), a button for the handle rod (32), a linkage rod (33), a first button handle (34), a second button handle (35), a handle lower base (36), a handle upper base (37), a fourth spring (38), a first set of screws (39), a second set of screws (40), a third set of screws (41), a fourth set of screws (42), a fifth set of screws (43) and a fifth spring (44), all of which are mechanically coupled with a main body component and a handle end component.

### BRIEF DESCRIPTION OF DRAWINGS AND TABLES

FIG. 1 is a schematic drawing illustrating the components of a flexible and adjustable toddler guard rail (100) according to one preferred embodiment of the invention;

FIG. 2 is a schematic drawing illustrating a toddler guard rail (210) installed with a door frame according to the preferred embodiment of the invention; and

FIG. 3 is a schematic drawing illustrating a toddler guard rail (310) installed to outside of a door according to the preferred embodiment of the invention.

### DETAILED DESCRIPTION OF THE INVENTION

The present invention provides an adjustable, flexible apparatus that can be used a guard rail. While the present invention may be embodied in many different formulas for the purpose of promoting an understanding of the principles of the invention, reference will be made to the embodiments illustrated in the drawings, tables and specific language will be used to describe the same. It will nevertheless be understood that no limitation or restriction of the scope of the invention is thereby intended. Any alterations and further implementations of the principles of the invention as described herein are contemplated as would normally occur to one skilled in the art to which the invention relates.

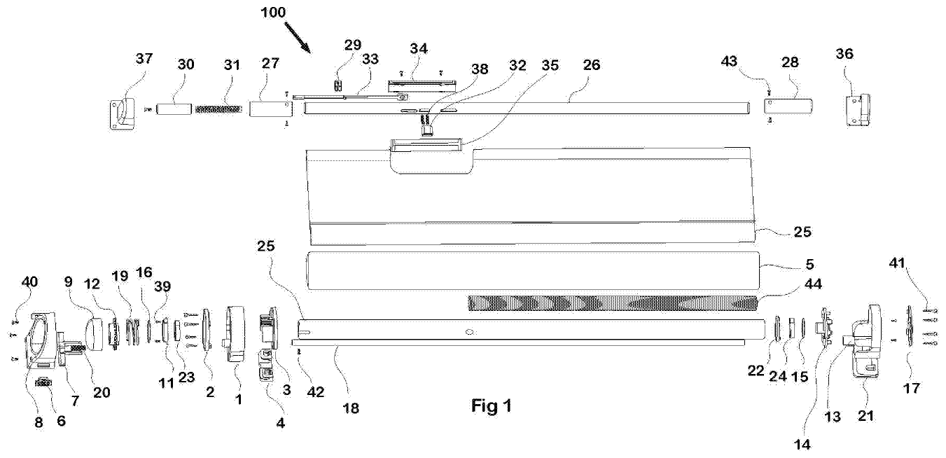

The present invention teaches an adjustable, flexible apparatus that can be used as a guard rail. FIG. 1 is a schematic drawing illustrating the components of a flexible and adjustable toddler guard rail (100) according to one preferred embodiment of the invention. As shown in the FIG. 1, the guard rail (100) includes an upper seat (1), an upper fix ring (2), an upper fix plate (3), an upper mounting base (4), a main body (5), two buttons (6), a switch bar (7), a upper base cover (8), a knob (9), a cloth winding tube (10), an upper sleeve (11) for the cloth winding tube (10), a fixing tooth (12) for the cloth winding tube (10), a base (13), a lower fixing plate (14), a gasket (15), a first washer (16) for the cloth winding tube (10), a bottom cover (17), a supporting rod (18), a first spring (19), a second spring (20), a lower mounting base (21), a pressure ring (22), a second washer (23) for the cloth winding tube (10), a bottom gasket (24), a mesh cloth (25), a handle rod (2), a handle upper sleeve (27), a handle lower sleeve (28), a spring limit (29), a pin (30), a third spring (31), a button for the handle rod (32), a linkage rod (33), a first button handle (34), a second button handle (35), a handle lower base (36), a handle upper base (37), a fourth spring (38), a first set of screws (39), a second set of screws (40), a third set of screws (41), a fourth set of screws (42), a fifth set of screws (43) and a fifth spring (44). The guard rail (100) contains a main body component and a handle end component assembled by the components above. The components (1) through (44) are mechanically coupled with the main body component and the handle end component.

The handle end component is assembled by mechanically coupling the following named and numbered components together in the sequence of: the handle rod (26) being inserted into the mesh cloth (25), the fourth spring (38) being placed or inserted into the button for the handle rod (32), the button for handle rod (32) being coupled together with the fourth spring (38) into the handle rod (26), the linkage rod (33) being inserted into the handle rod (26) where the hole is aligned with the inner cylinder of the second button handle (35) which is rubber-coated, the cylinder being pushed through the circular hole of the linkage rod (33) and at the same time, the first button handle (34), which is rubber-coated, being aligned with the second button handle (35) and being tightened or fixed with screws, the spring limit (29) being put into the designated position in the handle rod (26), the handle upper sleeve (27) being put on the outer mesh cloth (25) of the handle rod (26) and being aligned with the screw hole on the handle rod (26) and being tightened or fixed with screws; the third spring (31) being put into the handle rod (26), the pin (30) being set on the third spring (31) to align with the square position on the linkage rod (33) and then being tightened or fixed with screws, and at the same time, the handle lower sleeve (28) being put on the lower end of the handle rod (26), being aligned with the hole position and being fixed with the fifth set of screws (43).

The main body component is assembled by mechanically coupling the following named and numbered components together in the sequence of:

Part 1: Put the fifth spring (44) into the cloth winding tube (10), the end with the outer hook hooking into the round hole on the cloth winding tube (10), and put the cloth winding tube (10) into the mesh cloth (25), according to the direction, roll the mesh cloth (25) onto the cloth winding tube (10).

Part 2: Put the second washer (23) for the cloth winding tube (10) is put into the upper fixing plate (3), press it with the upper sleeve (11) for the cloth winding tube (10) and fixed with the first set of screws (39).

Part 3. Place the switch bar (7) into the upper seat cover (8), connect and fasten the switch bar (7) with the button (6).

Part 4. Put the gasket (15) and the bottom gasket (24) of the cloth winding tube (10) into the lower fixing plate (14) and fix them together with the pressure ring (22).

Part 5. Place the upper fixing disk (3) on the end surface of the main body (5), and fix the upper fixing ring ((2)) and the upper fixing disk (3) to the main body (5) with the third set of screws (41), insert the support rod (18) into the upper seat (1) and fix it with fourth screws (42); place the first spring (19) on the upper cover (11) of the cloth winding tube, wherein the beginning of the first spring (19) is just caught in the tooth between any side of the upper fixing plate (3) to fix the tooth of the cloth winding tube (10), pull the fixed tooth (12) of the cloth winding tube (10) on the first spring (19), pull the knob (9) on the fixed tooth (12) of the cloth winding tube (10), align the two protrusions on the knob (9) between the two slots in the upper seat cover (8), and put the second spring (20) into the corresponding hole of the upper seat (1), put the upper seat cover (8) on top pf the upper seat (1), and fix with the second set of screws (40) and make sure the arrow on the knob (9) corresponds to the two lock-shaped positions on the upper seat cover (8), and can be rotated to the specified position when the knob (9) is pressed).

Part 6. Treat the handle end component and the whole part of (1)/(2)/(3)/(5) of the main body component as a whole, keep it still, pull the fifth spring (44) out of the cloth winding tube (10) to the corresponding position of the lower fixed plate (14) with a tool and rotate the lower fixed plate (14) clockwise to the corresponding number of turns, until the lower fixed plate (14) end is up and the upper seat cover (8) end is down). Align the four-screw position of the lower fixed plate (14) with the four-screw hole column inside the main body (5) and keep it from rotating and insert the supporting rod (18) into the base (13) and fix them with screws, put the bottom cover (17) into the base (13) and align the lower fixing plate (14) with the screw holes and fix with screws.

In the preferred embodiment of the invention, the handle upper base (37) and the handle lower base (36) are used to fix the handle end component when installing the apparatus as a guard rail, and the upper mounting base (4) and the lower mounting base (21) ae used for fixing the main body component during installation.

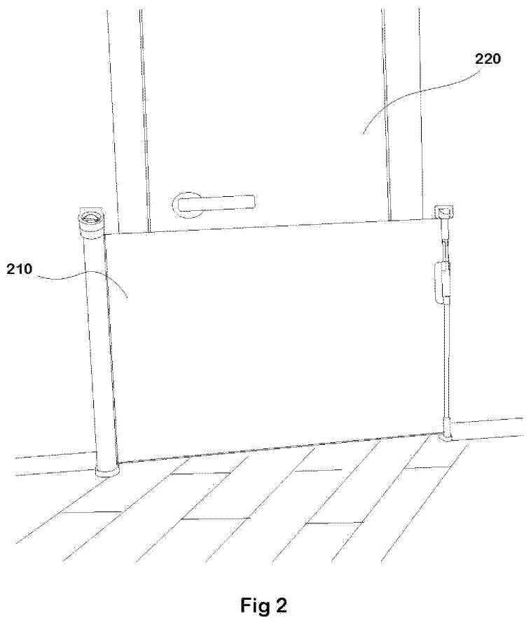

FIG. 2 is a schematic drawing illustrating a toddler guard rail (210) according to the preferred embodiment of the invention, which is installed onto a door frame 220. The guard rail can be installed by two or more screws and other coupling means.

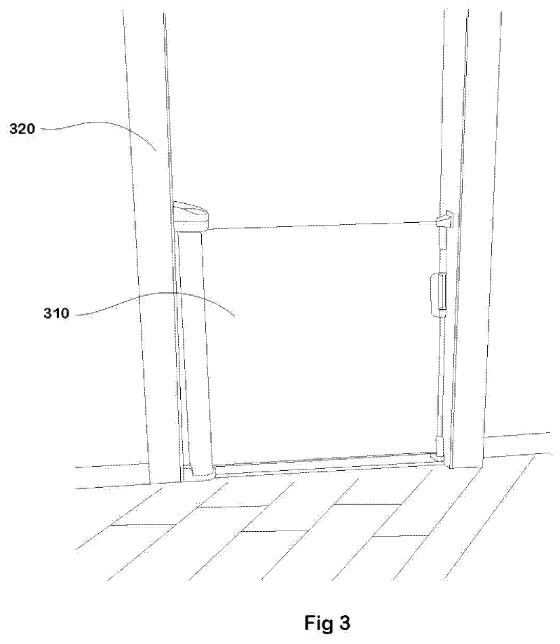

FIG. 3 is a schematic drawing illustrating a toddler guard rail (310) according to the preferred embodiment of the invention, which is installed outside a door frame 320.

The above detailed description of a portable, adjustable, flexible guard rail is illustrative but not restrictive. Many more embodiments may be added within the limit of the scope. Any modifications and adoptions without departing from the scope and spirit as set forth in the claims will still be within the protection of this invention.

I hereby claim:

1. An adjustable, flexible apparatus that can be used a guard rail, said apparatus comprises: an upper seat (1), an upper fix ring (2), an upper fix plate (3), an upper mounting base (4), a main body (5), two buttons (6), a switch bar (7), an upper base cover (8), a knob (9), a cloth winding tube (10), an upper sleeve (11) for said cloth winding tube (10), a fixing tooth (12) for said cloth winding tube (10), a base (13), a lower fixing plate (14), a gasket (15), a first washer (16) for said cloth winding tube (10), a bottom cover (17), a supporting rod (18), a first spring (19), a second spring (20), a lower mounting base (21), a pressure ring (22), a second washer (23) for said cloth winding tube (10), a bottom gasket (24), a mesh cloth (25), a handle rod (2), a handle upper sleeve (27), a handle lower sleeve (28), a spring limit (29), a pin (30), a third spring (31), a button for said handle rod (32), a linkage rod (33), a first button handle (34), a second button handle (35), a handle lower base (36), a handle upper base (37), a fourth spring (38), a first set of screws (39), a second set of screws (40), a third set of screws (41), a fourth set of screws (42), a fifth set of screws (43) and a fifth spring (44), which are mechanically coupled with a main body component and a handle end component.

2. The apparatus of claim 1, wherein:
said handle end component is assembled in a sequence of placing said handle rod (26) into said mesh cloth (25), placing said fourth spring (38) into said button for said handle rod (32), coupling said button for handle rod (32) and said fourth spring (38) to said handle rod (26), inserting said linkage rod (33) into said handle rod (26), wherein said hole is aligned with an inner cylinder of said second button handle (35), which is rubber-coated; pushing said cylinder through said circular hole of said linkage rod (33) and concurrently aligning said first button handle (34), which is rubber-coated, with said second button handle (35) and fixing them with screws, placing said spring limit (29) into a designated position in said handle rod (26), placing said handle upper sleeve (27) on said outer mesh cloth (25) of said handle rod (26), aligning it with said screw hole on said handle rod (26) and fixing it with screws, inserting said third spring (31) into said handle rod (26), setting said pin (30) on said third spring (31) to align with said square position on said linkage rod (33) and then fixing them with screws, pulling said handle lower sleeve (28) on said lower end of said handle rod (26), and aligning with said hole position and being fixed with said fifth set of screws (43); and
said main body component is assembled in a sequence of:
inserting said fifth spring (44) into said cloth winding tube (10), said end with said outer hook hooking into said round hole on said cloth winding tube (10), and inserting said cloth winding tube (10) into said mesh cloth (25), according to said direction, rolling said mesh cloth (25) onto said cloth winding tube (10);
inserting said second washer (23) for said cloth winding tube (10) into said upper fixing plate (3), pressing it with said upper sleeve (11) for said cloth winding tube (10) and being fixed with said first set of screws (39);
placing said switch bar (7) into said upper seat cover (8), connecting and fastening said switch bar (7) with said button (6);
placing said gasket (15) and said bottom gasket (24) of said cloth winding tube (10) into said lower fixing plate (14) and fixing them together with said pressure ring (22);
placing said upper fixing disk (3) on said end surface of said main body (5), and fixing said upper fixing ring (2) and said upper fixing disk (3) to said main body (5) with said third set of screws (41), inserting said support rod (18) into said upper seat (1) and fixing it with fourth screws (42), placing said first spring (19) on said upper cover (11) of said cloth winding tube (10), wherein a beginning of said first spring (19) is just caught in said tooth between any side of said upper fixing plate (3) to fix said tooth of said cloth winding tube (10), pulling said fixed tooth (12) of said cloth winding tube (10) on said first spring (19), pulling said knob (9) on said fixed tooth (12) of said cloth winding tube (10), align said two protrusions on said knob (9) between said two slots in said upper seat cover (8), and put said second spring (20) into said corresponding hole of said upper seat (1), putting said upper seat cover (8) on top pf said upper seat (1), and fixing with said second set of screws (40) and making sure said arrow on said knob (9) corresponding to two lock-shaped positions on said upper seat cover (8), and being rotatable to said specified position when said knob (9) being pressed; and
treating said handle end component and said assembly of (1)/(2)/(3)/(5) of said main body component as a whole, keeping it still, pulling said fifth spring (44) out of said cloth winding tube (10) to said corresponding position of said lower fixed plate (14) with a tool and rotating said lower fixed plate (14) clockwise to said corresponding number of turns, until said lower fixed plate (14) end is up and said upper seat cover (8) end is down, aligning said four-screw position of said lower fixed plate (14) with said four-screw hole column inside said main body (5) and keeping it from rotating and insert said supporting rod (18) into said base (13) and fixing them with screws, putting said bottom cover (17) into said base (13) and aligning said lower fixing plate (14) with said screw holes and fixing with screws.

3. The apparatus of claim 2, wherein said handle upper base (37) and said handle lower base (36) are used to fix said handle end component when installing said apparatus as a guard rail, and said upper mounting base (4) and said lower mounting base (21) are used for fixing said main body component during installation.

4. The Apparatus of claim 3, wherein said guard rail is installed onto a door frame.

5. The Apparatus of claim 4, wherein said guard rail is installed outside a door.
